(19) United States
(12) Patent Application Publication
(10) Pub. No.: US 2015/0360256 A1
(43) Pub. Date: Dec. 17, 2015

(54) REMELTING DURING DEPOSITION WELDING

(71) Applicant: SIEMENS AKTIENGESELLSCHAFT, München (DE)

(72) Inventors: Bernd BURBAUM, Falkensee (DE); Torsten JOKISCH, Neuenhagen bei Berlin (DE); Michael OTT, Mülheim an der Ruhr (DE); Sebastian PIEGERT, Lübbenau (DE)

(21) Appl. No.: 14/761,144

(22) PCT Filed: Dec. 19, 2013
(86) PCT No.: PCT/EP2013/077403

§ 371 Date: Jul. 15, 2015

(30) Foreign Application Priority Data
Jan. 18, 2013 (EP) 13151884.7

(51) Int. Cl. B05D 3/02; B23K 26/342; B32B 15/01; B23K 31/02

(52) U.S. Cl. CPC B05D 3/0254; B23K 31/02; B23K 26/342; B32B 15/01

(57) ABSTRACT

Remelting during deposition welding of layers (7, 7′, 7″) enables a desired micro structure (10′) having enlarged grains to be controlled, which leads to improved properties at high temperatures.

### CROSS-REFERENCE TO RELATED APPLICATIONS

The present application is a 35 U.S.C. §§371 national phase conversion of PCT/EP2013/077403, filed Dec. 19, 2013, which claims priority of European Application No. 13151884.7, filed Jan. 18, 2013, the contents of which are incorporated by reference herein. The PCT International Application was published in the German language.

### TECHNICAL FIELD

The invention relates to the remelting of deposition weld layers.

### TECHNICAL BACKGROUND

For components which are subject to load when they are in service, such as is known in the context of gas turbines for turbine blades, repair welds are performed, in which material is deposited. This can be done by laser deposition welding. Also known is laser beam remelting, in which cracks are remelted without deposition of material.

Deposition-welded layers often do not have the desired microstructure, in particular for the high-temperature properties.

It is an object of the invention, therefore, to solve the aforementioned problem.

### BRIEF DESCRIPTION OF THE DRAWINGS

FIGS. 1A-3 show steps of the method for remelting in deposition welding of the component according to the invention,

FIG. 4 shows a list of superalloys.

### DESCRIPTION OF EMBODIMENTS

The figures and the description represent only exemplary embodiments of the invention.

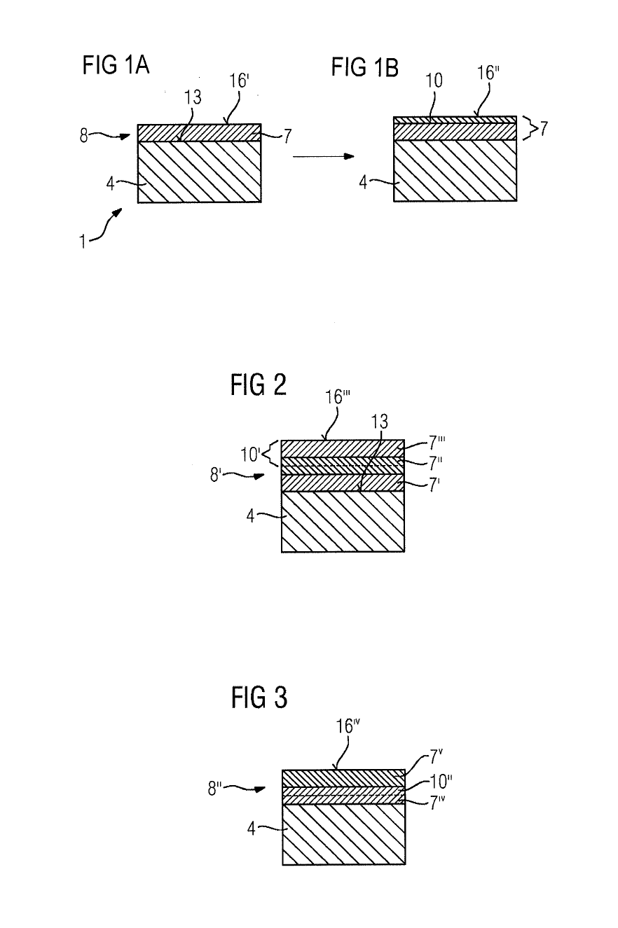

FIG. 1A shows, as the starting point, a component 1 with a substrate 4, on which is present a deposition weld 8 consisting of a deposition-welded layer 7.

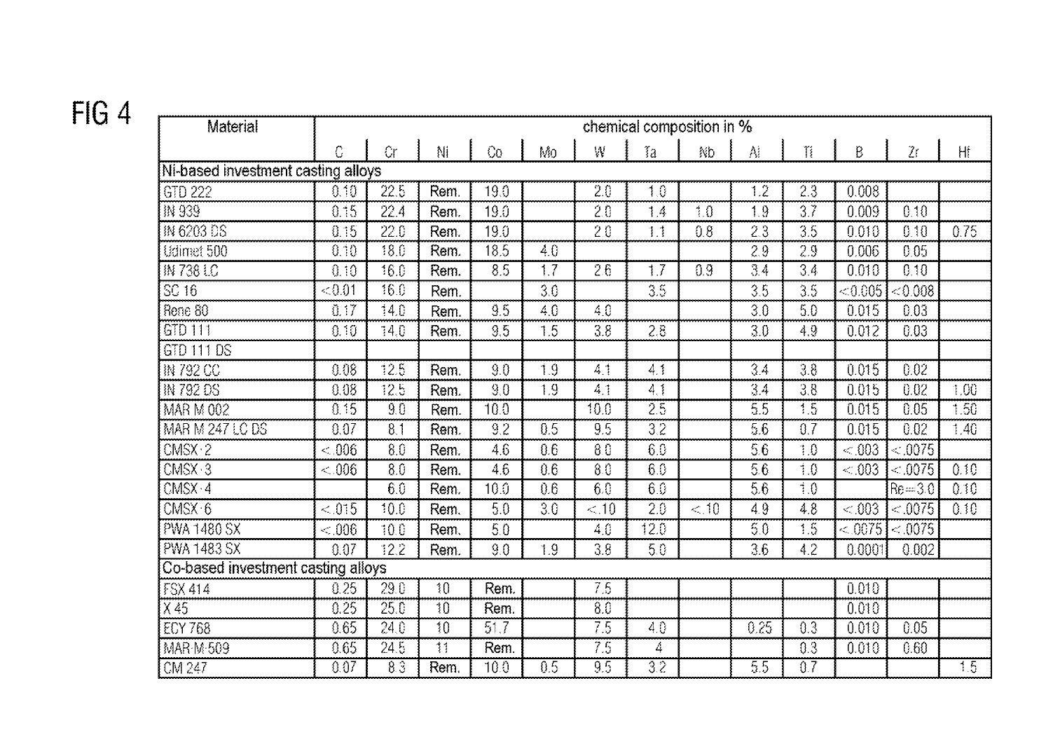

The substrate 4 is metallic and, in the case of gas turbine components, is preferably a nickel-based or cobalt-based superalloy, in particular as shown in FIG. 4.

The deposition weld 8, which was preferably created by laser deposition welding, is present on a surface 13 of the substrate 4.

The material of the deposition weld 8 may correspond to or be similar to the material of the substrate 4.

Referring to FIG. 1B, in order to increase grain size and to reduce the number of grain boundaries perpendicular to a direction of load, the surface 16′ of the deposition weld 8 is treated with a laser beam, such that there results, within the welded layer 7, a remelt region 10 with a surface 16″, as shown in FIG. 1B.

FIG. 2 shows another exemplary embodiment of the invention, in which multiple deposition-welded layers 7′, 7″, 7″′ are already present on the substrate 4 on the surface 13 of the latter, and there form the deposition weld 8′.

Only after multiple deposition-welded layers 7′, 7″, 7″′ are present is the remelting process carried out in order to generate a remelt region 10′ which then extends over one, in particular two, very particularly over multiple deposition-welded layers 7″′, 7″.

Preferably, not all of the deposition-welded layers 7′, 7″, 7″′ are encompassed.

This is then in particular the case when the height of the deposition-welded layers 7′, 7″, 7″′ is less than the target remelt depth of the remelt region 10′.

Referring to FIG. 3, it is equally possible, on a remelt region 10″ within a deposition-welded layer 7^{IV}, to deposit a further deposition-welded layer 7^{V} with a surface 16^{IV} which, with respect to grain size formation, attaches to the grain size of the remelt region 10″ (FIG. 3) and which is preferably not remelted.

The remelt region 10′, 10 (FIGS. 1, 2) or a deposition weld 7^{V} as shown in FIG. 3 can then represent the outermost surface 16″, 16″′, 16^{IV} onto which metallic protective layers (MCrAlX, PtAl, . . . ) and/or ceramic thermal barrier coatings (ZrO₂-Y₂O₃) are then deposited in a known manner.

Preferably, this method is suitable for substrates 4 solidified in a polycrystalline manner (FIGS. 1-3).

1-9. (canceled)

10. A method for deposition welding on a surface of a substrate, comprising generating a plurality of deposition-welded layers, and at least once performing a remelting procedure with the at least one deposition-welded layer for generating a remelt region in the at least one deposition-welded layer, wherein the remelt region extends over the plurality of deposition-welded layers.

11. The method as claimed in claim 10, further comprising:
depositing a further deposition-welded layer on the remelt region.

12. The method as claimed in claim 10, wherein the remelt region comprises an outermost layer of the deposition weld.

13. The method as claimed in claim 10, further comprising the depositing is performed on an outer surface of the remelt region, wherein the deposited layers differ significantly from the material of the deposition-welded layers.

14. A component produced as claimed in claim 10, wherein the component comprises a substrate with at least one of the deposition-welded layers and at least one remelt region within the at least one deposition-welded layer.

15. The component as claimed in claim 14, comprised of a plurality of the deposition-welded layers and an outer remelt region, which extends over at least one of the one deposition-welded layers.

16. The component as claimed in claim 10, further comprising at least one further deposition-welded layer on the remelt region, wherein the further deposition-welded layer is not remelted.

17. The component as claimed in claim 14, comprising on an outer surface of a remelt region there is at least one of a metallic protective layer and a ceramic protective layer, wherein the protective layers differ from the material of the deposition-welded layers.

18. The component as claimed in claim 17, wherein the protective layer is on an outer surface of a remelt region on a deposition-welded layer with an underlying remelt region.

19. The method as claimed in claim 10, further comprising depositing on an outer surface of a remelt region on a deposition-welded layer with an underlying remelt region, wherein the deposited layers differ from the material of the deposition welded layers.

20. The method as claimed in claim 10, further comprising:
depositing a further deposition-welded layer on the remelt region, wherein the deposition-welded layer is not remelted.

21. The method as claimed in claim 10, wherein the remelt region extends over fewer than all of the plurality of the deposition welded layers.
